(19) United States
(12) Patent Application Publication
(10) Pub. No.: US 2020/0233364 A1
(43) Pub. Date: Jul. 23, 2020

(54) DRIVE TRANSMITTER INCLUDING AN ELECTROMAGNETIC UNIT, AND IMAGE FORMING APPARATUS INCORPORATING THE DRIVE TRANSMITTER

(71) Applicants: Shinya SHIMIZU, Kanagawa (JP); Kaoru TADA, Kanagawa (JP)

(72) Inventors: Shinya SHIMIZU, Kanagawa (JP); Kaoru TADA, Kanagawa (JP)

(73) Assignee: Ricoh Company, Ltd., Tokyo (JP)

(21) Appl. No.: 16/732,448

(22) Filed: Jan. 2, 2020

(30) Foreign Application Priority Data
Jan. 22, 2019 (JP) 2019-008384

(51) Int. Cl. G03G 15/00; G03G 21/18; B41J 23/02

(52) U.S. Cl. CPC G03G 15/757; G03G 2221/1657; B41J 23/025; G03G 21/1857

(57) ABSTRACT

A drive transmitter including includes a first unit having an armature, a second unit, an electromagnetic unit, a rotary body, a cover portion, and a wall. The second unit is configured to couple with the first unit. The rotary body is disposed adjacent to the electromagnetic unit and overlapping the first unit and the second unit in an axial direction of the rotary body. The cover portion is mounted on one of the first unit and the second unit and configured to cover an outer circumferential surface of another one of the first unit and the second unit. A leading end of the cover portion in the axial direction and the outer circumferential surface of said another one of the first unit and the second unit are spaced apart by a gap. The wall is disposed between the gap and the rotary body.

### CROSS-REFERENCE TO RELATED APPLICATION

This patent application is based on and claims priority pursuant to 35 U.S.C. § 119(a) to Japanese Patent Application No. 2019-008384, filed on Jan. 22, 2019, in the Japan Patent Office, the entire disclosure of which is hereby incorporated by reference herein.

### BACKGROUND

### Technical Field

This disclosure relates to a drive transmitter including an electromagnetic unit, and an image forming apparatus incorporating the drive transmitter.

### Discussion of the Background Art

Various types of drive transmitters including an electromagnetic unit such as an electromagnetic clutch and an electromagnetic brake are known to include a first unit equipped with an armature, a second unit that is engaged with the first unit, and a cover portion that is provided on one of the first unit and the second unit and that surrounds an outer circumferential surface of the other unit of the first unit and the second unit.

### SUMMARY

At least one aspect of this disclosure provides a drive transmitter including a first unit having an armature, a second unit, an electromagnetic unit, a rotary body, and a cover. The second unit is configured to couple with the first unit. The rotary body is disposed adjacent to the electromagnetic unit and overlapping the first unit and the second unit in an axial direction of the rotary body. A cover portion is mounted on one of the first unit and the second unit and configured to cover an outer circumferential surface of another one of the first unit and the second unit. A leading end of the cover portion in the axial direction of the cover portion and the outer circumferential surface of said another one of the first unit and the second unit are spaced apart by a gap. The wall is disposed between the gap and the rotary body.

Further, at least one aspect of this disclosure provides an image forming apparatus including the above-described drive transmitter.

### BRIEF DESCRIPTION OF THE SEVERAL VIEWS OF THE DRAWINGS

An exemplary embodiment of this disclosure will be described in detail based on the following figured, wherein:

FIG. 1A is a diagram illustrating an electromagnetic clutch provided in a drive transmitter according to Embodiment 1;

FIG. 1B is a diagram illustrating the drive transmitter according to Embodiment 1;

FIG. 1C is a perspective view illustrating a cover provided in the drive transmitter of FIG. 1B;

FIG. 1D is a perspective view illustrating of the cover, viewed from a different angle of FIG. 1C;

FIG. 2 is a diagram illustrating an image forming apparatus according to Embodiment 2;

FIG. 3 is an enlarged view illustrating one of four image forming units;

FIG. 4 is a perspective view illustrating an image formation drive module, viewed from a rear side of the image forming apparatus of FIG. 2;

FIG. 5 is a perspective view illustrating the image formation drive module, viewed from the rear side of the image forming apparatus, in a state in which an intermediate bracket, a black image motor, and a color image drum motor are removed;

FIG. 6 is a perspective view illustrating the image formation drive module, viewed from the intermediate bracket;

FIG. 7 is an enlarged perspective view illustrating an image formation drive bracket, in an area near an internal external integrated gear;

FIG. 8 is a plan view illustrating the internal external integrated gear in FIG. 7;

FIG. 9 is a perspective view illustrating the internal external integrated gear of FIG. 7, viewed from a different angle;

FIG. 10 is a perspective view illustrating a resin bracket of a drive transmitter according to Embodiment 3 of this disclosure, in which the resin bracket composes a conveyance drive module and a drive transmission member contained in the resin bracket;

FIG. 11 is a perspective view illustrating the drive transmitter of Embodiment 3, in a state in which parts other than five electromagnetic clutches are removed from the resin bracket;

FIG. 12 is an enlarged perspective view illustrating an exploded state of a duplex clutch;

FIG. 13 is a diagram illustrating a rear side of the duplex clutch of FIG, 12;

FIG. 14 is a cross-sectional view illustrating the duplex clutch, viewed from an arrow along a line X-X in FIG. 13;

FIG. 15A is a diagram illustrating an electromagnetic clutch provided in a comparative drive transmitter;

FIG. 15B is a diagram illustrating the comparative drive transmitter with the electromagnetic clutch of FIG. 15A; and

FIG. 16 is a perspective view illustrating a drive transmitter according to Embodiment 3, in a state in which parts other than five electromagnetic brakes are removed from the resin bracket.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on”, “against”, “connected to” or “coupled to” another element or layer, then it can be directly on, against, connected or coupled to the other element or layer, or intervening elements or layers may be present. In contrast, if an element is referred to as being “directly on”, “directly connected to” or “directly coupled to” another element or layer, then there are no intervening elements or layers present. Like numbers referred to like elements throughout. As used herein, the term “and/or” includes any and all combinations of one or more of the associated listed items.

Spatially relative terms, such as “beneath”, “below”, “lower”, “above”, “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below The device may be otherwise oriented (rotated 90 degrees or at other orientations) and the spatially relative descriptors herein interpreted accordingly.

Although the terms first, second, etc, may be used herein to describe various elements, components, regions, layers and/or sections, it should be understood that these elements, components, regions, layer and/or sections should not be limited by these terms. These terms are used to distinguish one element, component, region, layer or section from another region, layer or section. Thus, a first element, component, region, layer or section discussed below could be termed a second element, component, region, layer or section without departing from the teachings of the present disclosure.

The terminology used herein is for describing particular embodiments and examples and is not intended to be limiting of exemplary embodiments of this disclosure. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Descriptions are given, with reference to the accompanying drawings, of examples, exemplary embodiments, modification of exemplary embodiments, etc., of a drive transmitter including an electromagnetic unit, and an image forming apparatus according to exemplary embodiments of this disclosure. Elements having the same functions and shapes are denoted by the same reference numerals throughout the specification and redundant descriptions are omitted. Elements that do not demand descriptions may be omitted from the drawings as a matter of convenience. Reference numerals of elements extracted from the patent publications are in parentheses so as to be distinguished from those of exemplary embodiments of this disclosure.

This disclosure is applicable to any drive transmitter including an electromagnetic unit, and image forming apparatus, and is implemented in the most effective manner in an electrophotographic image forming apparatus.

In describing preferred embodiments illustrated in the drawings, specific terminology is employed for the sake of clarity. However, the disclosure of this disclosure is not intended to be limited to the specific terminology so selected and it is to be understood that each specific element includes any and all technical equivalents that have the same function, operate in a similar manner, and achieve a similar result.

Referring now to the drawings, embodiments of the present disclosure are described below. In the drawings for explaining the following embodiments, the same reference codes are allocated to elements (members or components) having the same function or shape and redundant descriptions thereof are omitted below.

Hereinafter, an electrophotographic image forming apparatus (hereinafter simply referred to as an image forming apparatus) which forms an image by an electrophotographic system is described as an image forming apparatus including a drive transmitter including an electromagnetic unit according to this disclosure. In the following embodiments, a color laser printer is described as an example of the image forming apparatus. However, the image forming apparatus is not limited to a color printer but may be a color printer. The image forming apparatus is not limited to the printer and may be another image forming apparatus such as a copier and a multifunction peripheral. The image forming apparatus including the drive transmitter including an electromagnetic unit according to the present embodiment is not limited to the image forming apparatus of the electrophotographic system, and may be an image forming apparatus of another system such as an ink jet system.

### Embodiment 1.

A description is given of a drive transmitter 50 according to an embodiment of this disclosure (i.e., Embodiment 1).

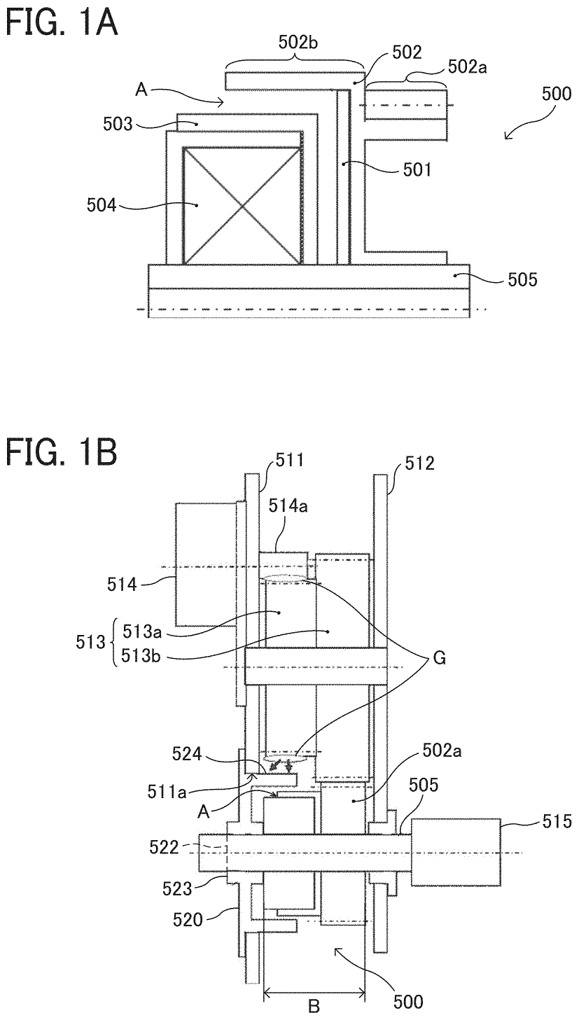

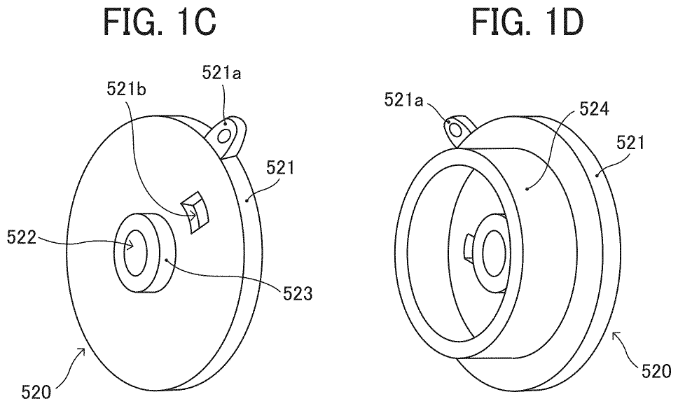

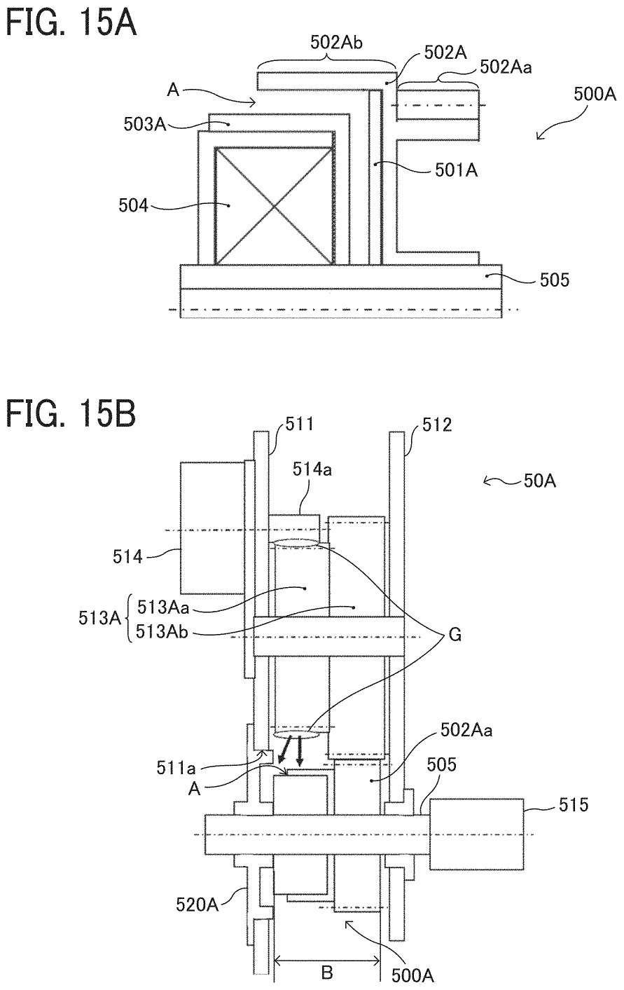

FIG. 1A is a diagram illustrating an electromagnetic clutch 500 provided in the drive transmitter 50 according to Embodiment 1. FIG. 1B is a diagram illustrating the drive transmitter 50 according to Embodiment 1. FIG. 1C is a perspective view illustrating a cover 520 provided in the drive transmitter 50 of FIG. 1B. FIG. 1D is a perspective view illustrating of the cover 520, viewed from a different angle of FIG. 1C. FIG. 15A is a diagram illustrating an electromagnetic clutch 500A provided in a comparative drive transmitter 50A. FIG. 15B is a diagram illustrating the comparative drive transmitter 50A with the electromagnetic clutch 500A of FIG. 1.5A.

FIG. 15A depicts the electromagnetic clutch 500A that is a gear integrated type clutch generally used in color printers.

The electromagnetic clutch 500A of a gear-integrated type is a dry type single disk electromagnetic clutch and includes a housing as a first unit to which an armature 501A is attached movably in the axial direction through a leaf spring. A gear 502Aa is formed on an outer circumferential surface of the housing to form a gear housing 502A that functions as a first unit. The gear housing 502A further includes a cover portion 502Ab. The cover portion 50Ab has a cylindrical shape and extends to surround an outer circumferential surface of a rotor 503A that functions as a second unit. The gear housing 502A is rotatably attached to an output shaft 505 via a bearing such as a ball bearing. The rotor 503A is fixed to the output shaft 505 and has a field incorporating a coil 504 is rotatably attached to the output shaft 505 via a bearing such as a ball bearing.

When the comparative drive transmitter 50A outputs a driving force via the electromagnetic clutch 500A, a motor gear that is meshed with the gear 502Aa is rotated to transmit the driving force to the gear housing 502A. As the electromagnetic clutch 500A is turned on, the electric current flows. Accordingly, the armature 501A that rotates together with the gear housing 502A is attracted to the rotor 503A to closely contact with the rotor 503A, and the rotor 503A that rotates together with the output shaft 505 is connected to the gear housing 502A. As a result, the driving force is transmitted to the output shaft 505.

The comparative drive transmitter 50A as illustrated in FIG. 15B is an example of a drive transmitter employing the electromagnetic clutch 500A in a drive train from a drive source to a driven body. A motor gear 514a is integrally formed with a motor 514 that functions as a drive source. The motor gear 514a is meshed with a small diameter portion 513Aa of an idler gear 513A. Marge diameter portion 513Ab of the idler gear 513A is meshed with the gear 502Aa of the gear housing 502A of the electromagnetic clutch 500A. With this configuration, the driving force is transmitted to the electromagnetic clutch 500A via the idler gear 513A. By turning on the electromagnetic clutch 500A, the driving force is transmitted to a drive target body 515.

The idler gear 513A and the electromagnetic clutch 500A are arranged in the space between retaining panels 511 and 512 that are made of a pair of sheet metals to reduce the size of the drive transmitter. Specifically, the idler gear 513A that functions as a rotary body is provided to have different positions overlapping with each other in the axial direction, in a range in the axial direction of the rotor 503A (including the field) and the gear housing 502A, indicated by arrow B in FIG. 15B. According to this configuration, a reduction is achieved in the size of the comparative drive transmitter 50A in the axial direction.

Due to consideration of the assembly and exchangeability of the electromagnetic clutch 500A, one end of the output shaft 505 of the electromagnetic clutch 500A is supported by a cover 520A that also functions as a bearing that closes a through hole 511a formed in the retaining panel 511 and the other end of the output shaft 505 of the electromagnetic clutch 500A is supported by a regular bearing to the retaining panel 512. The cover 520A is made of a slidable resin material to function as a bearing and includes a collar portion. An outer circumferential surface of the collar portion is fitted to an inner circumferential surface of the through hole 511a.

In known drive transmitters in recent years, grease is often applied to a drive train at the gear meshing portion in order to reduce wear and noise of the gears. Therefore, in a case in which viscous grease is used, it is likely that excessive grease is scattered around the drive transmitter or the image forming apparatus. Since grease G is applied to each gear provided in the comparative drive transmitter 50A illustrated in FIG. 15B, in a case in which an electromagnetic clutch is disposed in the vicinity of the portion where grease is applied, the scattered grease G is likely to adhere to the electromagnetic clutch in the comparative drive transmitter. In a case in which the scattered grease G enters from the gap A (see FIG. 15A) between the tip of the cover portion 502Ab and the outer circumferential surface of the rotor 503A, the scattered grease G is likely to go through a donut-shaped space between the cover portion 502Ab and the outer circumferential surface of the rotor 503A to adhere to the surface of the armature 501A and the surface of the rotor 503A facing the armature 501A. Oil contained in the grease G adversely affects the operation of the electromagnetic clutch 500A. Specifically, the above-described inconvenience is likely to cause failure of the electromagnetic clutch 500A in a normal clutch connection and disconnection operation. In addition, foreign materials such as wear powder as well as grease is also likely to cause malfunction of the electromagnetic clutch 500A. In the configuration of the comparative drive transmitter 50A in FIG. 15B, the cover portion 502Ab of the gear housing 502A does not fully cover the rotor 503A in the axial direction of the rotor 503A. In other words, the cover portion 502Ab surrounds the rotor 503A leaving a given area of the rotor 503A uncovered. That is, the cover portion 502Ab partially covers the rotor 503A in the axial direction. Consequently, this configuration of the comparative drive transmitter 50A is likely to cause inconvenience easily due to the reason that the distance from the gap A to a portion between the armature 501A and the rotor 503A is relatively short.

In order to address the above-described inconvenience of the comparative drive transmitter 50A, the comparative drive transmitter 50A provides a drive transmitter 50 according to Embodiment 1 of this disclosure as illustrated in FIGS. 1A to 1D. The configuration of the drive transmitter 50 of FIGS. 1A to 1D is basically identical to the comparative drive transmitter 50A of FIGS. 15A and 15B, except that the drive transmitter 50 according to Embodiment 1 includes a cover 520 disposed on a coil side of the electromagnetic clutch 500. The cover 520 has a wall having a round shape that covers the coil. Specifically, the cover 520 has a collar 524 that functions as a wall. The collar 524 fits into the through hole 511a of the retaining panel 511. The collar 524 is extended longer in the axial direction than the collar portion of the cover 520A of the comparative drive transmitter 50A so as to form a wall between the small diameter portion 513a of the idler gear 513 and a gap A formed between a cover portion 502b of a gear housing 502 and a rotor 503. As illustrated in the configuration of the drive transmitter 50 in FIG. 1 B, the cover portion 502b of the gear housing 502 does not fully cover the rotor 503 in the axial direction of the rotor 503. In other words, the cover portion 502b surrounds the rotor 503 leaving a given area of the rotor 503 uncovered. That is, the cover portion 502b partially covers the rotor 503 in the axial direction. FIG. 1D clearly illustrates the wall (i.e., the collar 524) having a round shape. As illustrated in FIGS. 1C and 1D, the cover 520 includes a shaft through hole 522, a boss 523, a disc-shaped cover member 521, a screw hole member 521a for screwing the cover 520 to the retaining panel 511, a through hole 521b to allow a cord from the electromagnetic clutch 500 to pass, and the collar 524. The collar 524 surrounds and covers the shaft through hole 522 and the boss 523 in the gap A over an entire circumference of the collar 524. Here, the term “entire circumference” includes a circumference that exists substantially over 360 degrees and has a portion cut by a minute angle.

According to the present embodiment, Embodiment 1, the cover 520 on the coil side of the electromagnetic clutch 500 is provided with the collar 524 having a round wall shape that covers the coil to prevent adhesion of grease to the electromagnetic clutch 500 and the mixing of foreign material. The configuration of the drive transmitter 50 prevents a clutch connection and disconnection malfunction due to grease or foreign material without adding a cover component, and therefore enables implementation of a highly reliable drive transmitter. The configuration of the drive transmitter 50 in FIGS. 1A to 1D including the cover 520 having the collar 524 shields a region between the small diameter portion 513a of the idler gear 513 and an uncovered area of the outer circumferential surface of the rotor 503, in which the uncovered area is the given area of the rotor 503 left uncovered by the cover portion 502b Therefore, the configuration of the drive transmitter 50 is further effective to prevent adhesion of grease.

In particular, in :Embodiment 1, the wall (i.e., the collar 524) between the electromagnetic clutch 500 and the gear and gear train ares concentric with the electromagnetic clutch 500, thereby simplifying the layout of the drive train. Since the wall (i.e., the collar 524) between the electromagnetic clutch 500 and the gear and gear train is integrally provided, as a single unit, with the cover 520 that functions as a bracket that holds the electromagnetic clutch 500, the reliability of the electromagnetic clutch 500 is improved without adding new components. Furthermore, the cover 520 as the holding bracket is formed of a slidable material, and therefore the holding bracket (i.e., the cover 520) functions as a bearing of an electromagnetic clutch shaft. At the same time, the cover 520 uses a sliding material for the sliding surface, and therefore the durability of the cover 520 is improved.

### Embodiment 2

Next, a description is given of an image forming apparatus 100 according to an embodiment of this disclosure (i.e., Embodiment 2).

First, a description is given of the basic configuration of the image forming apparatus 100 according to Embodiment 2.

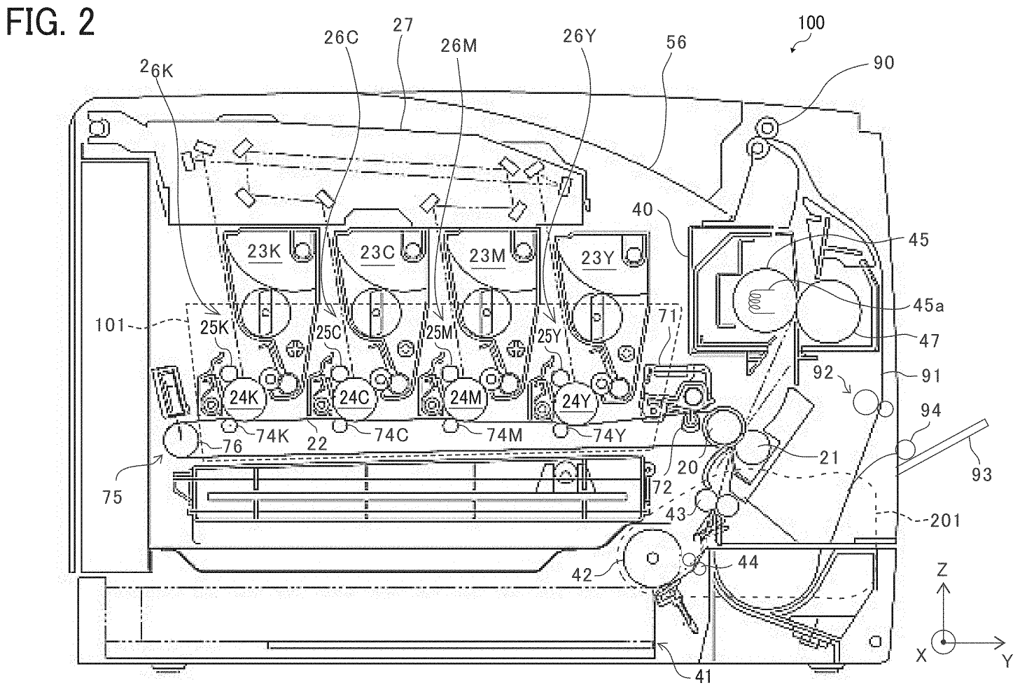

FIG. 2 is a diagram illustrating the image forming apparatus 100 according to Embodiment 2.

It is to be noted in the following examples that: the term “image forming apparatus” indicates an apparatus in which an image is formed on a recording medium such as paper, OHP (overhead projector) transparencies, OHP film sheet, thread, fiber, fabric, leather, metal, plastic, glass, wood, and/or ceramic by attracting developer or ink thereto; the term “image formation” indicates an action for providing (i.e., printing) not only an image having meanings such as texts and figures on a recording medium but also an image having no meaning such as patterns on a recording medium; and the term “sheet” is not limited to indicate a paper material but also includes the above-described plastic material (e.g., an OHP sheet), a fabric sheet and so forth, and is used to which the developer or ink is attracted. In addition, the “sheet” is not limited to a flexible sheet but is applicable to a rigid plate-shaped sheet and a relatively thick sheet.

Further, size (dimension), material, shape, and relative positions used to describe each of the components and units are examples, and the scope of this disclosure is not limited thereto unless otherwise specified.

Further, it is to be noted in the following examples that: the term “sheet conveying direction” indicates a direction in which a recording medium travels from an upstream side of a sheet conveying path to a downstream side thereof; the term “width direction” indicates a direction basically perpendicular to the sheet conveying direction.

It is to be noted that reference sign “X” indicates is a direction from the front side to the rear side of the image forming apparatus 100, reference sign “Y” indicates is a direction from the left side to the right side of the image forming apparatus 100, and reference sign “Z” indicates is a direction perpendicular to the direction X and the direction Y.

As illustrated in FIG. 2, the image forming apparatus 1100 includes four image forming units 26K, 26C, 26M, and 26Y for forming toner images of black (K), cyan (C), magenta (M), and yellow (Y).

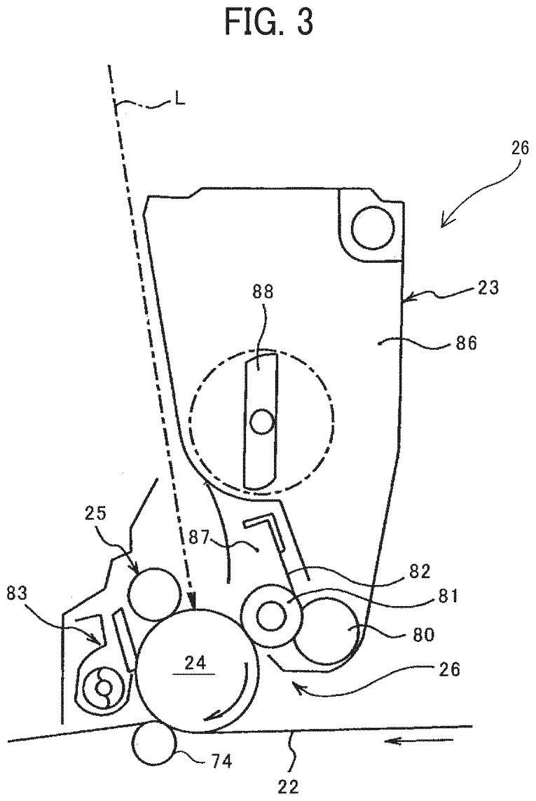

FIG. 3 is an enlarged view illustrating one of four image forming units 26K, 26C, 26M, and 26Y.

Since the image forming unit of FIG. 3 is applied to any one of the image forming units 26K, 26C, 26M, and 26Y of FIG. 2, the image forming unit 26 is illustrated without the suffixes K, C, M, and Y in FIG. 3.

In the image forming unit 26 (i.e., the image forming units 26K, 26C, 26M, and 26Y), a charging unit 25 (i.e., charging units 25K, 25C, 25M, and 25Y) uniformly charges the surface of a photoconductor drums 24 (i.e., a black photoconductor drum 24K and color photoconductor drums 24C, 24M, and 24Y) that functions as a latent image bearer driven to rotate in the clockwise direction in FIG. 3, The uniformly charged surface of the photoconductor drum 24 is exposed and scanned by laser light L. emitted from an optical writing unit 27 and carries an electrostatic latent image for each of colors. This electrostatic latent image is developed into a toner image by a developing unit 23 with toner. The toner image is then transferred onto an intermediate transfer belt 22 as primary transfer.

A photoconductor drum cleaning unit 83 removes residual toner remaining on the surface of the photoconductor drum 24 after the primary transfer process. Alternatively, an electric charge removing unit removes residual charge remaining on the surface of the photoconductor drum 24 after the primary transfer process. After the removal of residual toner or residual electric charge from the surface of the photoconductor drum 24, the image forming unit 26 is prepared for the subsequent image forming operation.

The developing unit 23 illustrated in FIG. 3 further includes a vertically long hopper 86 and a developing portion 87. The vertically long hopper 86 stores toner as developer. The vertically long hopper 86 includes an agitator 88 that is rotationally driven by a driving device, and a toner supply roller 80. A developing portion 87 of the developing unit 23 includes a developing roller 81 and a thinning blade 82.

As illustrated in FIG. 2, the optical writing unit 27 that functions as a latent image writing device is disposed above the image forming units 26K, 26C, 26M, and 26Y in the vertical direction.

A transfer unit 75 is disposed below the image forming units 26K, 26C, 26M, and 26Y in the vertical direction. The transfer unit 75 includes an intermediate transfer belt 22, a drive roller 76, a tension roller 20, four primary transfer rollers 74K, 74C, 74M, and 74Y, a secondary transfer roller 21, a belt cleaning unit 71, and a cleaning backup roller 72.

A sheet tray 41 is disposed below the transfer unit 75 in the vertical direction. The sheet tray 41 has a sheet feed roller 42 in contact with the uppermost sheet in a sheet bundle. The sheet tray 41 rotates the sheet feed roller 42 in a counterclockwise direction of FIG. 2 at a given timing, so as to feed the uppermost sheet toward a sheet conveyance passage.

A pair of registration rollers 43 that includes two registration rollers is disposed near the end of the sheet conveyance passage. The pair of registration rollers 43 feeds a sheet toward a secondary transfer nip region at a timing at which movement of the sheet is synchronized with a four-color toner image formed on the intermediate transfer belt 22 in the above-described secondary transfer nip region. A relay roller 44 is also provided in the sheet conveyance passage.

The four-color toner image formed on the intermediate transfer belt 22 being in close contact with the sheet at the secondary transfer nip region is subjected to collective secondary transfer onto the sheet due to the secondary transfer electric field and nip pressure. The sheet having the full-color toner image thus formed on the surface passes through the secondary transfer nip region, then is separated from the secondary transfer roller 21 and the intermediate transfer belt 22 by curvature separation and is conveyed to the fixing unit 40 as a fixing unit.

The fixing unit 40 fixes the unfixed toner image on the sheet to the sheet by application of pressure by a fixing roller 45 incorporating a heat source 45a such as a halogen lamp and heat by a pressure roller 47. The sheet discharged from the fixing unit 40 is conveyed to a pair of sheet ejection rollers 90.

In a case in which a single-sided printing mode is selected, the sheet nipped in a sheet ejection nip region of the pair of sheet ejection rollers 90 is discharged directly to the outside of the image forming apparatus 100 by the forward rotation of the pair of sheet ejection rollers 90. Then, the sheet is stacked in a stacking unit 56 provided on the upper surface of a top cover of a housing of the image forming apparatus 100.

On the other hand, in a case in which a duplex printing mode is selected, the sheet nipped in the sheet ejection nip region of the pair of sheet ejection rollers 90 is conveyed to the outside of the image forming apparatus 100 to some extent, and then rotation of the pair of sheet ejection rollers 90 is reversed to convey the sheet back to the image forming apparatus 100, so as to enter a reverse conveyance passage 91. Subsequently, the sheet is turned upside down through a duplex sheet conveyance nip region of a pair of duplex conveyance rollers 92, and then reenters the sheet conveyance passage so as to be re-conveyed to the pair of registration rollers 43. Thereafter, the sheet is conveyed to the secondary transfer nip region at a given timing and a toner image is transferred onto the other face of the sheet by secondary transfer. Thereafter, the sheet is discharged to the outside of the image forming apparatus 100 through the fixing unit 40 and the pair of sheet ejection rollers 90, so as to be stacked in the stacking unit 56.

The surface of the intermediate transfer belt 22 after passing through the secondary transfer nip region is cleaned by the belt cleaning unit 71. The cleaning backup roller 72 supports up the belt cleaning unit 71 from the inside of the loop of the intermediate transfer belt 22.

A bypass tray 93 is provided on a side cover of the housing of the image forming apparatus 100 so as to be openable and closable with respect to the side cover. The sheet is fed to the bypass tray 93 is conveyed to the pair of registration rollers 43 in the sheet conveyance passage by the rotational drive of a bypass sheet feed roller 94.

An area illustrated with a broken line is an installation area of an image formation drive module 101 that drives an image formation system.

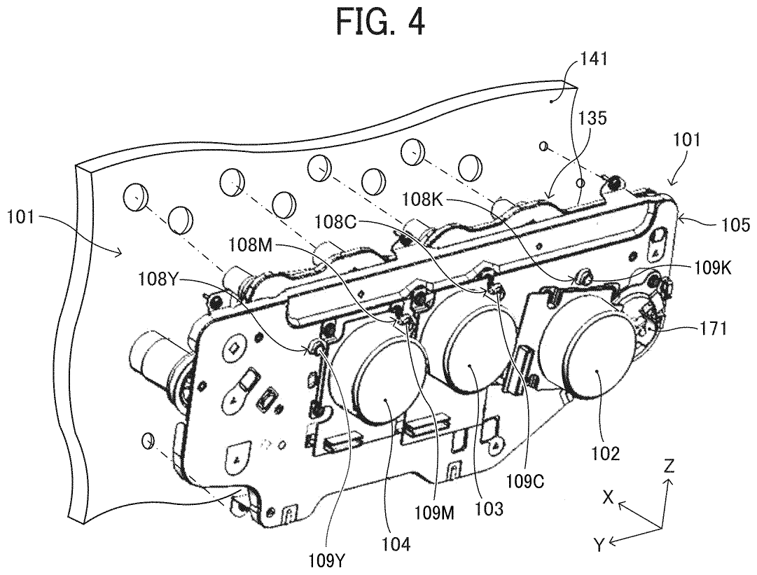

FIG. 4 is a perspective view illustrating an image formation drive module 101, viewed from a rear side of the image forming apparatus 100 of FIG. 2.

The image formation drive module 101 includes an image formation drive bracket 105 and an intermediate bracket 135. Both the image formation drive bracket 105 and the intermediate bracket 135 are formed of sheet metal and connected and spaced apart from each other in a parallel state. The image formation drive module 101 is attached to a rear side plate 141 of the housing of the image forming apparatus 100 in a posture with the intermediate bracket 135 arranged on the front side of the housing of the image forming apparatus 100. A black image motor 102 is attached to the rear side of the image formation drive bracket 105. The black image motor 102 drives a black photoconductor drum 24K, the black developing unit 23K, and the drive roller 76 of the transfer unit 75. A color image drum motor 103 is also attached to the rear side of the image formation drive bracket 105. The color image drum motor 103 drives the color photoconductor drums 24C, 24M, and 24Y A color image developing motor 104 drives color image developing units 23C, 23M, and 23Y.

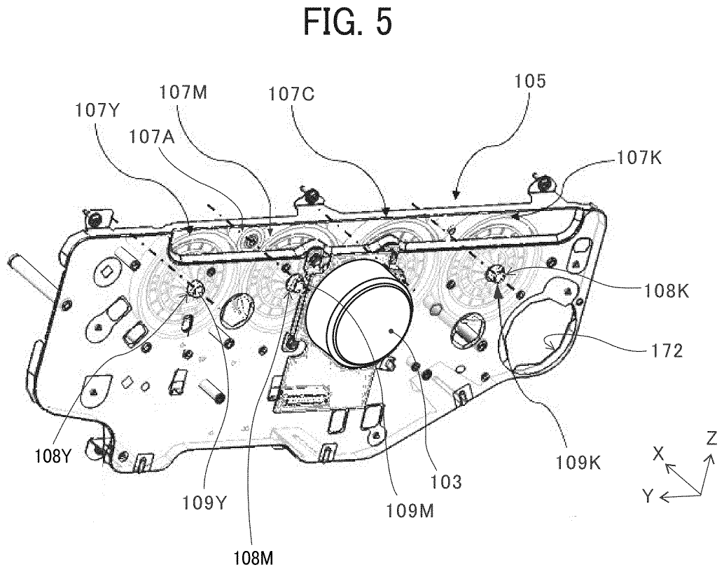

FIG. 5 is a perspective view illustrating the image formation drive module 101, viewed from the rear side of the image forming apparatus 100, in a state in which an intermediate bracket 135, the black image motor 102, and the color image drum motor 103 e removed.

As illustrated to be seen through in FIG. 5, photoconductor drum gears 107K, 107C, 107M, and 107Y and an idler gear 107A are disposed on the front side of the image formation drive bracket 105. One shaft ends 109K, 109C, 109M, 109Y of each of these gears is supported by the image formation drive bracket 105. A motor gear of the color image drum motor 103 is meshed with the photoconductor drum gear 107C and the photoconductor drum gear 107M. The idler gear 107A is meshed with the photoconductor drum gear 107M and the photoconductor drum gear 107Y.

The motor gear of the black image motor 102 is meshed with the photoconductor drum gear 107K and penetrates onto the front side of the intermediate bracket 135. The motor gear of the color image developing motor 104 passes through the front side of the intermediate bracket 135 without meshing with any of the photoconductor drum gears 107K, 107C, 107M, and 107Y The image formation drive bracket 105 also has a clutch replacement hole 172 to switch between driving connection and drive disconnection to the black developing unit 23K. The clutch replacement hole 172 is covered from the back side, with a cover 171 that is illustrated on the right side of the black image motor 102 in FIG. 4.

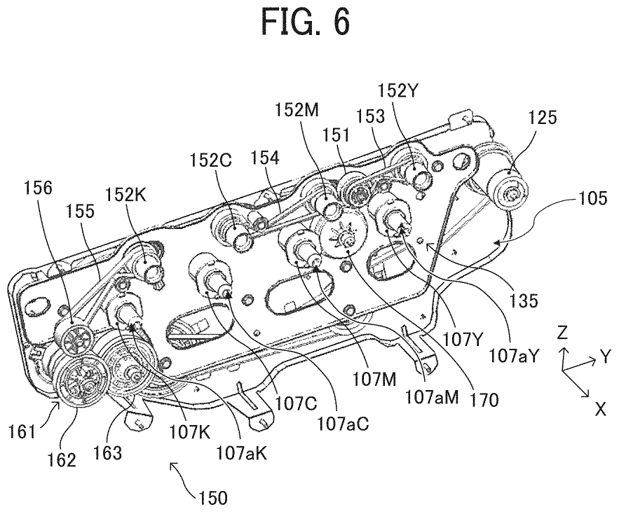

FIG. 6 is a perspective view illustrating the image formation drive module 101, viewed from the intermediate bracket 135.

The intermediate bracket 135 holds a developing internal and external teeth integrated gear 170 having the internal teeth being meshed with the motor gear of the color image developing motor 104. The intermediate bracket 135 also holds an idler gear pulley 151 and an M-color drive output gear pulley 152M that are meshed with the external teeth of the developing internal and external teeth integrated gear 170. The intermediate bracket 135 also holds a Y-color drive output gear 152Y and a C-color drive output gear 1520. The Y-color drive output gear 152Y is driven and transmitted by a timing belt 153 via the idler gear pulley 151. The C-color drive output gear 152C is driven and transmitted by a timing belt 154 via the M-col or drive output gear pulley 152M.

Shafts 107aK, 107aC, 107aM, and 107aY of the photoconductor drum gears 107K, 107C, 107M, and 107Y respectively penetrate through the intermediate bracket 135 and protrude to the front side. At the tip of this shaft, male and female connection is performed with each of the black photoconductor drum 24K and the color photoconductor drums 24C, 24M, and 24Y.

The intermediate bracket 135 also holds a K-color drive output gear 152K and an idler gear pulley 156 connected to the K-color drive output gear 152K by a timing belt 155. On the image formation drive bracket 105, the idler gear pulley 156 is meshed with an output gear 162 firmly fixed to the output shaft of the electromagnetic clutch 161 for switching the drive connection and drive disconnection to the black developing unit 23K. The electromagnetic clutch 161 is held on the front side of the image formation drive bracket 105. The gear of the gear housing meshes with an external gear of an internal external integrated gear 163 held on the front side of the image formation drive bracket 105.

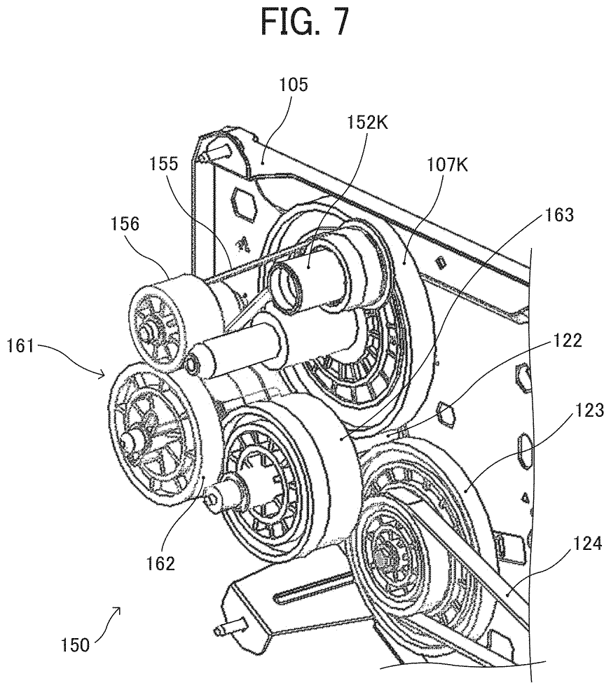

FIG. 7 is an enlarged perspective view illustrating the image formation drive bracket 105, in an area near the internal external integrated gear 163. The intermediate bracket 135 is removed in FIG. 7.

A motor gear 122 of the black image motor 102 that is meshed with the internal teeth of the internal external integrated gear 163 is also meshed with the photoconductor drum gear 107K and the gear of the idler gear pulley 123 for secondary transfer. A timing belt 234 wound over a pulley of the idler gear pulley 123 transmits the driving force to the secondary transfer output gear 125 (see FIG. 5) via a timing belt different from a relay pulley.

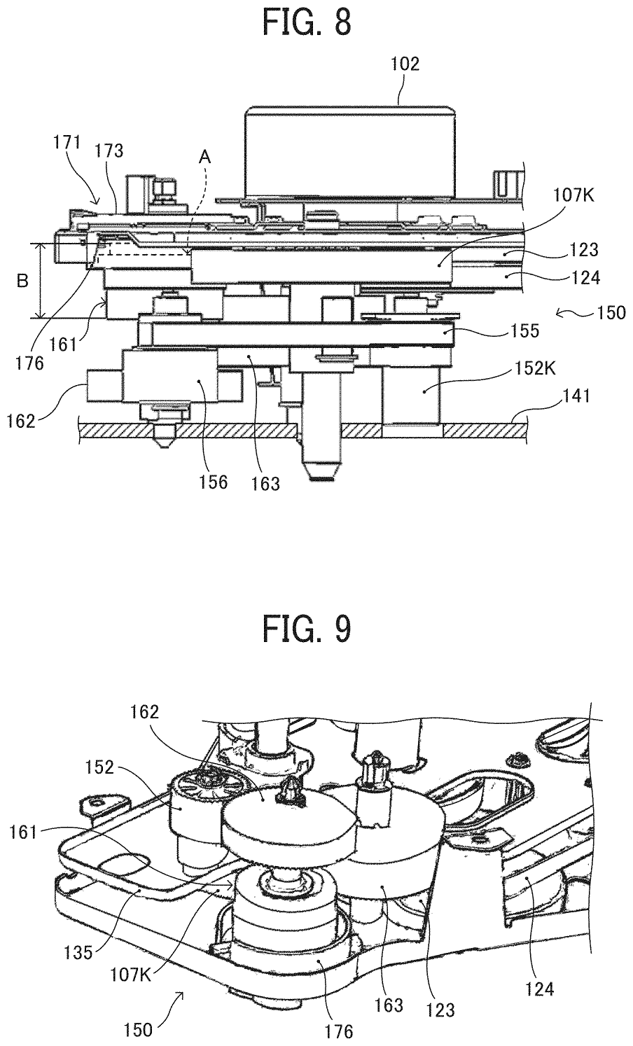

FIG. 8 is a plan view illustrating the internal external integrated gear 163 in FIG. 7.

A gear of the photoconductor drum gear 107K, a gear of the idler gear pulley 123, and external teeth of the internal external integrated gear 163 are located close to the electromagnetic clutch 161 at a position of the electromagnetic clutch 161 that overlaps with the range B in the axial direction of the rotor 503 and the gear housing 502. Therefore, grease that is applied to these gears is likely to adhere to the electromagnetic clutch 161, resulting in a failure.

FIG. 9 is a perspective view illustrating the internal external integrated gear 163 of FIG. 7, viewed from a different angle.

In order to prevent grease from adhering to the electromagnetic clutch 161, a cover 171 has the same material and shape as the cover 520 illustrated in FIGS. 1C and 1D. Specifically, the cover 171 includes a disk-shaped cover member 173 and a collar 176. The height of the collar 176 in the axial direction is increased similar to the cover 520 illustrated in FIGS. 1C and la Specifically, as illustrated in FIG. 8, the height of the collar 176 in the axial direction is set to a height extending to the gear housing side beyond the position in the axial direction of the gap A between the tip of the cover portion of the gear housing of the electromagnetic clutch 161 and the outer circumference of the rotor 503. With this configuration, a wall having a round shape is formed between the gap A and each of the above-described gears.

### Embodiment 3

Next, a description is given of a drive transmitter 250 according to Embodiment 3 of this disclosure, in which this disclosure is applied to electromagnetic clutches different from the electromagnetic clutch 161 of the drive transmitter 150 of Embodiment 2. Except for the above-described feature, the configuration of the drive transmitter 250 is identical to the configuration of the drive transmitter 150 of Embodiment 2.

An area illustrated with a broken line is an installation area of a conveyance drive module 201 that drives a sheet conveyance system. In Embodiment 3, this disclosure is applied to electromagnetic clutches (i.e., a duplex clutch 203, a registration clutch 204, a relay roller clutch 205, a bypass clutch 206, and a sheet feed clutch 207) provided on the conveyance drive module 201.

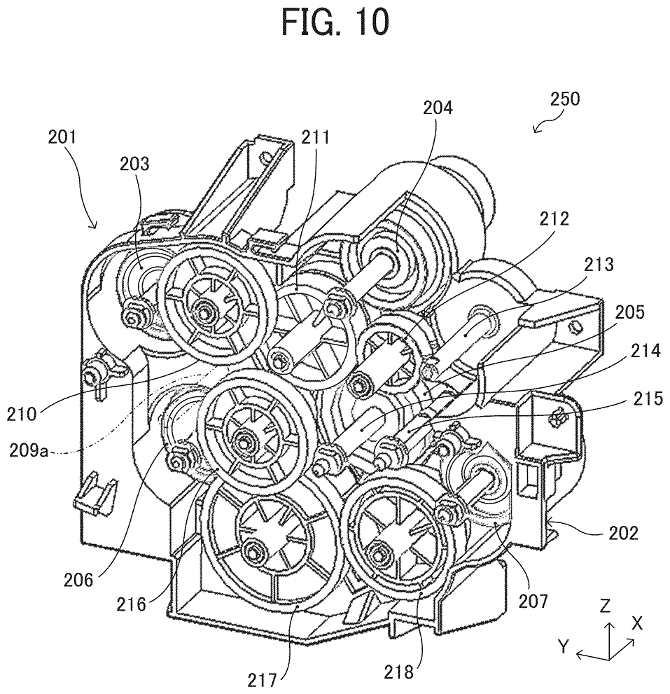

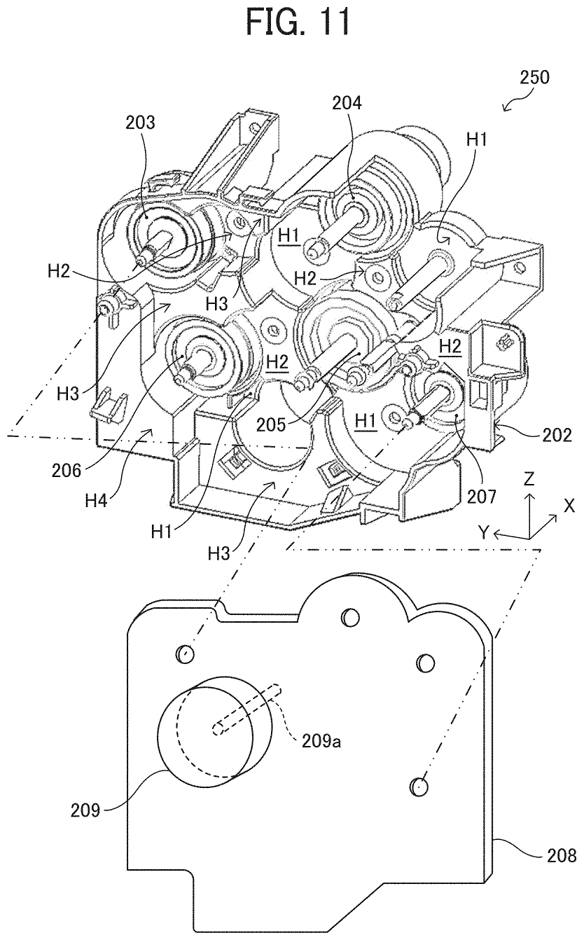

FIG. 10 is a perspective view illustrating a resin bracket 202 of the drive transmitter 250, in which the resin bracket 202 composes the conveyance drive module 201 and a drive transmission member contained in the resin bracket 202. FIG. 11 is a perspective view illustrating the drive transmitter 250 of Embodiment 3, in a state in which parts other than five electromagnetic clutches (i.e., the duplex clutch 203, the registration clutch 204, the relay roller clutch 205, the bypass clutch 206, and the sheet feed clutch 207) are removed from the resin bracket 202.

FIG. 11 also illustrates a conveyance drive bracket 208 formed of a sheet metal to be attached to the resin bracket 202. A conveyance motor 209 is attached to the conveyance drive bracket 208. The conveyance drive bracket 208 also includes a bearing hole to receive the shaft of the electromagnetic clutch.

In FIG. 10, an output gear 209a of the conveyance motor 209 is meshed with a large gear portion of the first relay gear 210. A small gear portion of the first relay gear 210 is meshed with a housing gear of the duplex clutch 203 and a front gear of a second relay gear 211 in FIG. 10. The second relay gear 211 is meshed with a housing gear of the registration clutch 204 at a gear on the rear side of the resin bracket 202 in FIG. 10 and, at the same time, is meshed with a third relay gear 212 at a gear on the front side of the resin bracket 202 in FIG. 10. The third relay gear 212 is meshed with a housing gear of the relay roller clutch 205 and a gear of a gear pulley that is firmly fixed to a pulley shaft 213. (It is to be noted that the gear pulley is removed in FIG. 10.) A timing belt is wound over a pulley of the gear pulley. The timing belt transmits the driving force to a sheet ejection roller 90 (see FIG. 2). A gear that is firmly fixed to a shaft 214 of the relay roller clutch 205 is meshed with a gear that is firmly fixed to the relay roller shaft 215. (It is to be noted that the gear fixed to the shaft 214 and the gear fixed to the relay roller shaft 215 are removed in FIG. 10.)

The output gear 209a of the conveyance motor 209 is meshed with a large gear portion of a fourth relay gear 216. A small gear portion of the fourth relay gear 216 is meshed with a housing gear of the bypass clutch 206 and a fifth relay gear 217. The fifth relay gear 217 is meshed with a large gear portion of a sixth relay gear 218. A small gear portion of the sixth relay gear 218 is meshed with a housing gear of the sheet feed clutch 207.

The driving force is transmitted from the conveyance motor 209 to respective housing gears of the electromagnetic clutches (i.e., the duplex clutch 203, the registration clutch 204, the relay roller clutch 205, the bypass clutch 206, and the sheet feed clutch 207) by the above-described drive transmission members, and then the electromagnetic clutches the duplex clutch 203, the registration clutch 204, the relay roller clutch 205, the bypass clutch 206, and the sheet feed clutch 207) are connected by energization. Then, the driving force is transmitted toward a downstream side in the sheet conveyance direction, to the pair of duplex conveyance rollers 92, the registration roller 43, the registration roller 43, the bypass sheet feed roller 94, and the sheet feed roller 42. Similar to the above-described embodiments, in the configuration of the drive transmitter 250 according to Embodiment 3, grease is applied to various gears and the respective tooth surfaces to enhance the durability and reduce the noise.

In FIG. 11, the relay gears, specifically, the first relay gear 210, the second relay gear 211, the third relay gear 212, the fourth relay gear 216, the fifth relay gear 217, and the sixth relay gear 218 are disposed on faces H1 to H4 of the resin bracket 202. Each value of 1 to 4 of the faces H1 to H4 indicates a distance to the conveyance drive bracket 208. The larger value indicates a smaller distance. Faces rise from the rims of the faces H1 to H4 toward the conveyance drive bracket 208. When viewed from the conveyance drive bracket 208, respective recesses are formed with the faces H1 to H4 as bottom faces. Hereinafter, the faces H1 to H4 are occasionally referred to as bottom faces H1 to H4. From this point of view, it is expressed that the bottom face with the smaller value is deeper than the bottom face with the greater value. For example, the bottom face H1 is deeper than the bottom face H4.

FIG. 12 is an enlarged perspective view illustrating an exploded state of the duplex clutch 203.

The face on which the duplex clutch 203 is disposed corresponds to the bottom face H1, and therefore has the same depth as the face on which the second relay gear 211 is disposed adjacent to the duplex clutch 203 via the first relay gear 210. A bottom face H2 of the first relay gear 210 is shallower than the bottom face H1 and a bottom face H3 is shallower than the bottom face H2 of the first relay gear 210. The bottom face H2 of the first relay gear 210 and the bottom face H3 are located between the bottom face H1 of the duplex clutch 203 and the bottom face H1 of the second relay gear 211.

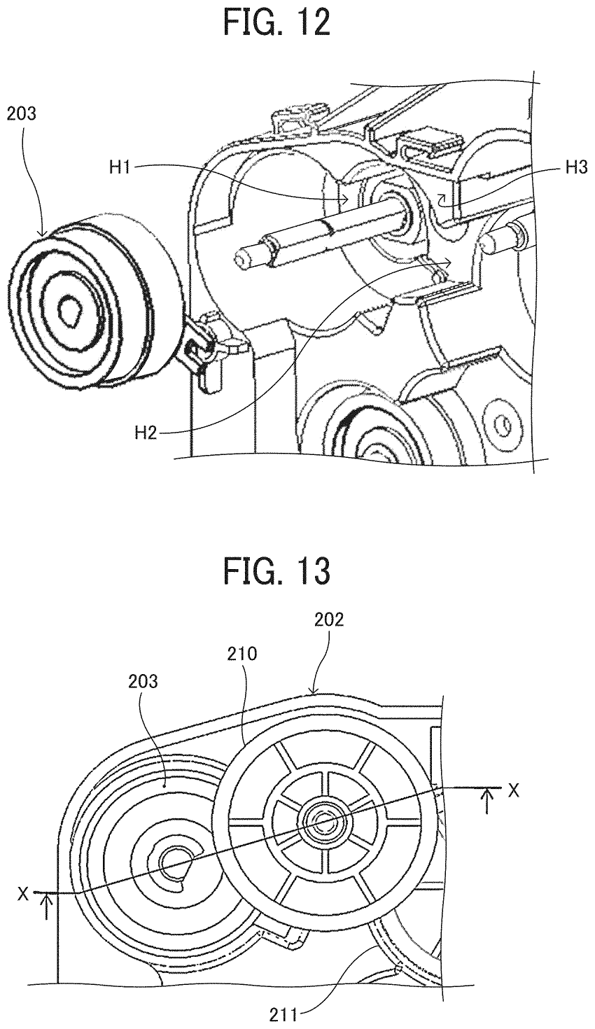

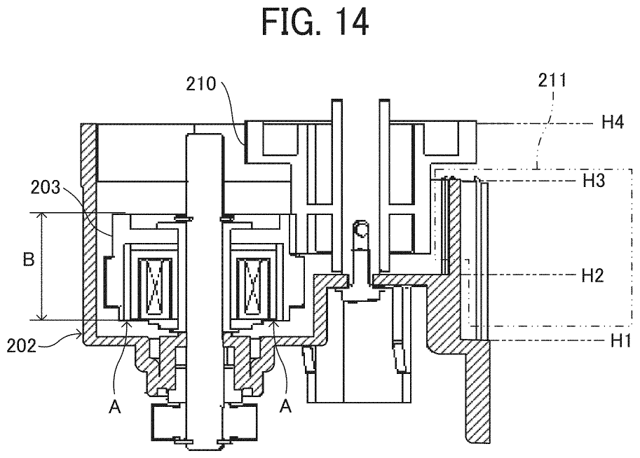

FIG. 13 is a diagram illustrating a rear side of the duplex clutch 203 of FIG. 12. FIG. 14 is a cross-sectional view illustrating the duplex clutch 203, viewed from an arrow along a line X-X in FIG. 13. In FIG. 14, the resin bracket 202 alone is hatched, and reference signs H1 to H4 are assigned to individual faces.

As illustrated in FIG. 14, the small gear portion of the first relay gear 210 and the front and rear gear portions of the second relay gear 211 are disposed within a range B in an axial direction of the rotor 503 (including the field) of the duplex clutch 203 and the gear housing 502. In addition, there is a gap A between the leading end of the cover 520 of the gear housing 502 of the duplex clutch 203 and the outer circumferential surface of the roller. Further, the resin bracket 202 has a shallow portion in the inner face to form the bottom face H2 and the bottom face H3 between the gears. The shallow portion functions as a wall that prevents grease applied, in particular, to the tooth surface of the second relay gear 211 out of the gears adjacent to the gap A from coming and entering the gap A.

Among the other electromagnetic clutches (i.e., the registration clutch 204, the relay roller clutch 205, the bypass clutch 206, and the sheet feed clutch 207) illustrated in FIG. 11, the bypass clutch 206 has the bottom face H1 and the electromagnetic clutches, that is, the registration clutch 204, the relay roller clutch 205, and the sheet feed clutch 207 have respective bottom faces that are deeper than the bottom face H1 of the bypass clutch 206. According to this configuration, the wall rising from a rim of the bottom face prevents grease scattered from the gear adjacent to the wall from adhering to the electromagnetic clutches (i.e., the duplex clutch 203, the registration clutch 204, the relay roller clutch 205, the bypass clutch 206, and the sheet feed clutch 207).

Even in Embodiment 3, the coil of the gear integrated electromagnetic clutch is disposed facing the housing (the resin bracket), so that the electromagnetic clutches are prevented from grease entering the electromagnetic clutches. At the same time, the electromagnetic clutches are surrounded and covered by the housing, so that the electromagnetic clutches are prevented from grease entering the electromagnetic clutches with higher accuracy. As described above, the housing is provided with a function of preventing grease from entering the electromagnetic clutches. With this configuration, the reliability of operation of the electromagnetic clutches is enhanced with a simple structure without further providing new parts or components.

Although each of the above-described embodiments uses an electromagnetic clutch or multiple electromagnetic clutches, the embodiments are similarly applied to a configuration using an electromagnetic brake or multiple electromagnetic brakes. For example, an electro

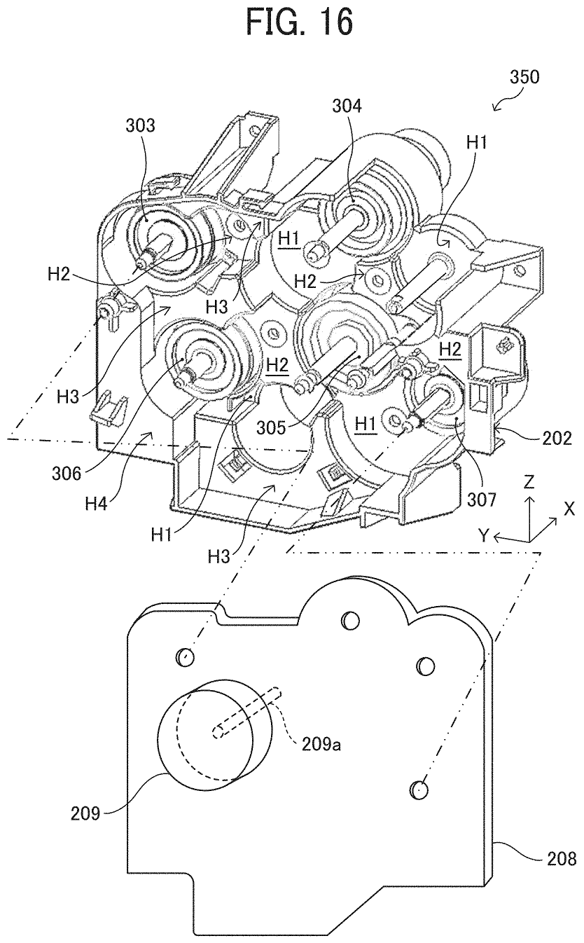

FIG. 16 is a perspective view illustrating a drive transmitter 350 in a state in which parts other than five electromagnetic brakes (i.e., a duplex brake 303, a registration brake 304, a relay roller brake 305, a bypass brake 306, and a sheet feed brake 307) are removed from the resin bracket 202.

It is to be noted that the configuration of the drive transmitter 350 is basically identical to the configuration of the drive transmitter 250, except that the drive transmitter 350 includes the electromagnetic brakes (i.e., the duplex brake 303, the registration brake 304, the relay roller brake 305, the bypass brake 306, and the sheet feed brake 307) while the drive transmitter 250 includes the electromagnetic clutches(i.e., the duplex clutch 203, the registration clutch 204, the relay roller clutch 205, the bypass clutch 206, and the sheet feed clutch 207).

Similar to the drive transmitter 250 in FIGS. 10 and 11, the drive transmitter 350 in FIG. 16 includes the output gear 209a of the conveyance motor 209 that is meshed with a large gear portion of the first relay gear 210. The small gear portion of the first relay gear 210 is meshed with the housing gear of the duplex brake 303 and the front gear of the second relay gear 211. The second relay gear 211 is meshed with the housing gear of the registration brake 304 at the gear on the rear side of the resin bracket 202 and, at the same time, is meshed with the third relay gear 212 at the gear on the front side of the resin bracket 202. The third relay gear 212 is meshed with a housing gear of the relay roller brake 305 and the gear of the gear pulley that is firmly fixed to the pulley shaft 213. The timing belt is wound over the pulley of the gear pulley. The timing belt transmits the driving force to the sheet ejection roller 90 (see FIG. 2). The gear that is firmly fixed to the shaft 214 of the relay roller brake 305 is meshed with the gear that is firmly fixed to the relay roller shaft 215.

The output gear 209a of the conveyance motor 209 is meshed with the large gear portion of the fourth relay gear 216. The small gear portion of the fourth relay gear 216 is meshed with a housing gear of the bypass brake 306 and the fifth relay gear 217. The fifth relay gear 217 is meshed with the large gear portion of the sixth relay gear 218. The small gear portion of the sixth relay gear 218 is meshed with a housing gear of the sheet feed brake 307.

The driving force is transmitted from the conveyance motor 209 to respective housing gears of the electromagnetic brakes (i.e., the duplex brake 303, the registration brake 304, the relay roller brake 305, the bypass brake 306, and the sheet feed brake 307) by the above-described drive transmission members, and then the electromagnetic brakes(i.e., the duplex brake 303, the registration brake 304, the relay roller brake 305, the bypass brake 306, and the sheet feed brake 307) are connected by energization. Then, the driving force is transmitted toward the downstream side in the sheet conveyance direction, to the pair of duplex conveyance rollers 92, the registration roller 43, the registration roller 43, the bypass sheet feed roller 94, and the sheet feed roller 42. Similar to the above-described embodiments, in the configuration of the drive transmitter 350, grease is applied to various gears and the respective tooth surfaces to enhance the durability and reduce the noise.

Similar to FIG. 11, the relay gears, specifically, the first relay gear 210, the second relay gear 211, the third relay gear 212, the fourth relay gear 216, the fifth relay gear 217, and the sixth relay gear 218 in FIG. 16 are disposed on the bottom faces H1 to H4 of the resin bracket 202. Numbers 1 to 4 of the bottom faces H1 to H4 indicate the distance to the conveyance drive bracket 208. The larger value indicates a smaller distance. Faces rise from the rims of the bottom faces H1 to H4 toward the conveyance drive bracket 208. When viewed from the conveyance drive bracket 208, respective recesses are formed with the bottom faces H1 to H4. From this point of view, it is expressed that the bottom face with the smaller value is deeper than the bottom face with the greater value. For example, the bottom face H1 is deeper than the bottom face H4.

Among the other electromagnetic brakes (i.e., the registration brake 304, the relay roller brake 305, the bypass brake 306, and the sheet feed brake 307) illustrated in FIG. 16, the bypass brake 306 has the bottom face H1 and the electromagnetic brakes, that is, the registration brake 304, the relay roller brake 305, and the sheet feed brake 307 have respective bottom faces that are deeper than the bottom face H1 of the bypass brake 306. According to this configuration, the wall rising from the rim of the bottom face prevents grease scattered from the gear adjacent to the wall from adhering to the electromagnetic brakes (i.e., the duplex brake 303, the registration brake 304, the relay roller brake 305, the bypass brake 306, and the sheet feed brake 307).

As described in the above embodiments, this disclosure is applicable to any configuration using an electromagnetic clutch, multiple electromagnetic clutches, an electromagnetic brake, or multiple electromagnetic brakes. Moreover, this disclosure is applicable to a meshing type as well as to a friction type. Slippage due to adhesion of grease and operation instability due to adhesion of foreign matter occur in a similar manner, and the above-described embodiments would obviously be also effective for these issues.

Incidentally, a known application discloses a configuration in which a cover having a cup shape with a bottom covers the electromagnetic clutch. The cover is assumed to be fixed to a side plate of the drive transmitter and is considered as a single electromagnetic clutch. There is no suggestion or description in the known application about the configuration for a reduction (a downsizing) in a case in which the rotary body is disposed adjacent to the electromagnetic clutch and overlapped with the electromagnetic clutch in the axial direction. Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

The effects described in the embodiments of this disclosure are listed as most preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of the invention, and are included in the scope of the invention recited in the claims and its equivalent.

Any one of the above-described operations may be performed in various other ways, for example, in an order different from the one described above.

What is claimed is:

1. A drive transmitter comprising:
a first unit having an armature;
a second unit configured to couple with the first unit;
an electromagnetic unit;
a rotary body disposed adjacent to the electromagnetic unit and overlapping the first unit and the second unit in an axial direction of the rotary body; and
a cover portion mounted on one of the first unit and the second unit and configured to cover an outer circumferential surface of another one of the first unit and the second unit,
a leading end of the cover portion in the axial direction and the outer circumferential surface of said another one of the first unit and the second unit being spaced apart by a gap; and
a wall disposed between the gap and the rotary body.

2. The drive transmitter according to claim 1,
wherein the electromagnetic unit is an electromagnetic clutch, and
wherein the rotary body is a drive transmission member.

3. The drive transmitter according to claim 2,
wherein the cover portion is configured to partially cover the outer circumferential surface of said another one of the first unit and the second unit in the axial direction, and
wherein the wall is configured to shield a region between the rotary body and an uncovered area of the outer circumferential surface uncovered by the cover portion.

4. The drive transmitter according to claim 2,
wherein the wall is configured to surround the gap between the leading end of the cover portion in the axial direction and the outer circumferential surface of said another one of the first unit and the second unit over an entire circumference of the wall.

5. The drive transmitter according to claim 2, further comprising a bracket configured to hold said another one of the first unit and the second unit,
wherein the wall is integral part of the bracket.

6. The drive transmitter according to claim 5,
wherein the bracket is a slidable bearing.

7. An image forming apparatus comprising the drive transmitter according to claim 2.

8. The drive transmitter according to claim 1,
wherein the electromagnetic unit is an electromagnetic brake, and
wherein the rotary body is a drive transmission member.

9. The drive transmitter according to claim 8,
wherein the cover portion is configured to partially cover the outer circumferential surface of said another one of the first unit and the second unit in the axial direction, and
wherein the wall is configured to shield a region between the rotary body and an uncovered area of the outer circumferential surface uncovered by the cover portion.

10. The drive transmitter according to claim 8,
wherein the wall is configured to surround the gap between the leading end of the cover portion in the axial direction and the outer circumferential surface of said another one of the first unit and the second unit over an entire circumference of the wall.

11. The drive transmitter according to claim 8, further comprising a bracket configured to hold said another one of the first unit and the second unit,
wherein the wall is integral part of the bracket.

12. The drive transmitter according to claim 11,
wherein the bracket is a slidable bearing.

13. An image forming apparatus comprising the drive transmitter according to claim 8.
